(19) United States
(12) Patent Application Publication
(10) Pub. No.: US 2013/0223952 A1
(43) Pub. Date: Aug. 29, 2013

(54) Wall mounted anchor assembly with reinforcing insert

(71) Applicant: Joseph F. Hickey, Ortley Beach, NJ (US)

(72) Inventor: Joseph F. Hickey, Ortley Beach, NJ (US)

(21) Appl. No.: 13/385,500

(22) Filed: Feb. 23, 2012

(51) Int. Cl. F16B 21/00

(52) U.S. Cl. 411/345

(57) ABSTRACT

A wall mounted anchor assembly in the form of a metal toggle bolt on which there is slidably received onto the metal shank portion a reinforcing plug insert which positions itself within the aperture drilled in the hollow wall for acceptance of the anchor assembly, the reinforcing plug insert insuring that the shank portion of the toggle bolt and the toggle bolt itself are centered within the hole after tightening.

### BACKGROUND OF THE INVENTION

1. Field of the Invention

The present invention relates to anchor assemblies for use with hollow walls, and in particular, to standard toggle bolt installation assemblies and a reinforcing insert for use with the toggle bolt to center the shank portion of the toggle bolt in the drilled aperture when the assembly is secured.

2. Description of the Prior Art

When heavy objects are to be hung from a wall or attached to a ceiling, with the ceiling or the wall being hollow, a standard threaded fastener is oftentimes insufficient. For these installations, toggle bolt assemblies have been developed. The toggle bolt assembly itself consists of a bolt, having a threaded shank portion, and a head portion, there being positioned on the threaded shank portion, a toggle assembly which comprises two spring loaded arms pivotal from an orientation in substantial alignment with the threaded shank to an orientation substantially transverse to the threaded shank. The diameter of the threaded shank portion and the length of the pivotal arm portions vary depending upon the size and weight of the object to be hung. The greater the size and the greater the weight, the greater the diameter and the greater the dimensions of the threaded shank and pivotal arms.

The installation of the toggle assembly requires the drilling of a aperture through the hollow wall of a diameter so as to accommodate the threaded shank and the toggle assembly when the toggle arms are pivoted in a parallel orientation with the threaded shank. Thus the size of the threaded shank and the size of the toggle arms dictate the diameter of the aperture to be drilled.

Once the desired aperture has been drilled, the threaded shank is inserted through the object to be hung on the wall or the ceiling and the toggle assembly is threadedly secured to the end of the threaded shank. The toggle arms are then positioned in orientation parallel to the threaded shank and inserted through the drilled aperture. Once the toggle assembly has passed through the drilled aperture and is now on the blind side of the hollow wall, the spring loaded toggle arms will automatically reorient to a position transverse to the threaded shank. The installer would then use the appropriate tool concomitant with the head of the bolt to tighten the bolt through the toggle assembly thus drawing the toggle assembly in abutting, juxtaposed frictional engagement with the blind side of the hollow wall thereby affixing the hook fastener or the like to the wall and/or the ceiling for the hanging of the desired object.

Toggle bolts to which the Applicant's invention relates have been'available for many years. The particular toggle bolt consists of a metal bolt and a toggle assembly and composed of a biasing spring and toggle arms threadedly secured onto the metal bolt, the toggle arms and biasing means also being fabricated from metal.

The shortcoming with respect to the toggle bolt assembly described is that the aperture drilled to accommodate the threaded shank and the toggle assembly in almost every instance is greater than the diameter of the threaded shank. Thus when the toggle assembly is inserted through the aperture and the toggle arms orient into a transverse orientation with the threaded shank, the threaded shank is of substantially less diameter than the drilled aperture. No matter how tight the installer secures the toggle bolt, the portion of the threaded shank positioned within the drilled aperture has a diameter substantially less than the diameter of the drilled aperture. Therefore when weight is positioned on the hook or other object secured to the outer surface of the wall by the toggle bolt, there is always the possibility and the likely possibility that the toggle bolt will move within the drilled aperture. This movement under load, would normally be downwardly until that portion of the threaded shank within the drilled aperture rested upon the lowest arc of the drilled aperture. However, under certain conditions this movement could be up, down, or side to side. This movement is undesirable, particularly when the toggle assembly is being used to hang a portrait, or a heavy mirror in which the installer has taken great pains to locate the exact height and position that the installer desires to hang the portrait or mirror. It also creates problems when toggle assemblies are used for the installation of other wall hanging devices, such as shelving and the like. The movement of the toggle can create wear and tear on the wall, whether it be sheetrock, plaster, paneling, or any other wall products used to define a hollow wall. Additionally, the only structural strength of the toggle assembly of the prior art is the torque affected by the installer in tightening the bolt, and in particular, the threaded shank with the toggle assembly squeezing the toggle assembly against the wall.

### OBJECTS OF THE INVENTION

An object of the present invention is to provide for a novel reinforcing plug insert for use with metal toggle bolt assemblies to insure the centering of the threaded shank of the toggle bolt in the drilled aperture after assembly.

A further object of the present invention is to provide for a novel reinforcing plug insert for use with metal toggle bolt assemblies which insures the centering of the metal threaded shank of the toggle bolt assembly in the drilled aperture and prevents wear and tear from side to side or up and down movement of the threaded shank within the drilled aperture on the wall material.

### SUMMARY OF THE INVENTION

A wall mounted anchor assembly in the form of a metal toggle bolt on which there is slidably received onto the metal shank portion a reinforcing plug insert which positions itself within the aperture drilled in the hollow wall for acceptance of the anchor assembly, the reinforcing plug insert insuring that the shank portion of the toggle bolt and the toggle bolt itself are centered within the hole after tightening.

### BRIEF DESCRIPTION OF THE DRAWINGS

These and other objects of the present invention will become apparent, particularly when taken in light of the following illustrations wherein:

FIG. 1 is a front view of the reinforcing plug insert;

FIG. 2 is a side view of the reinforcing plug insert;

FIG. 3 is a rear view of the reinforcing plug insert;

FIG. 4 is a rear perspective view of the reinforcing plug insert;

FIG. 5 is a front perspective view of the reinforcing plug insert;

FIG. 6 is a side view of the reinforcing plug insert with the toggle bolt assembly prior to insertion in a hollow wall; and

FIG. 7 is a cutaway side view of the assembly positioned in a hollow wall.

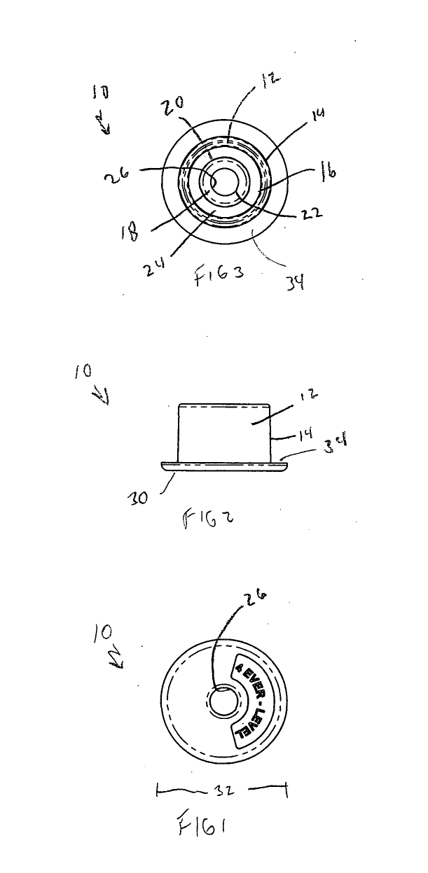

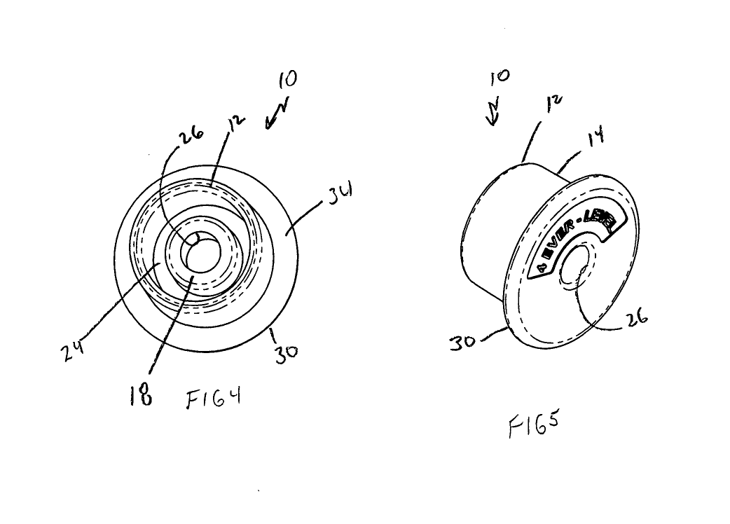

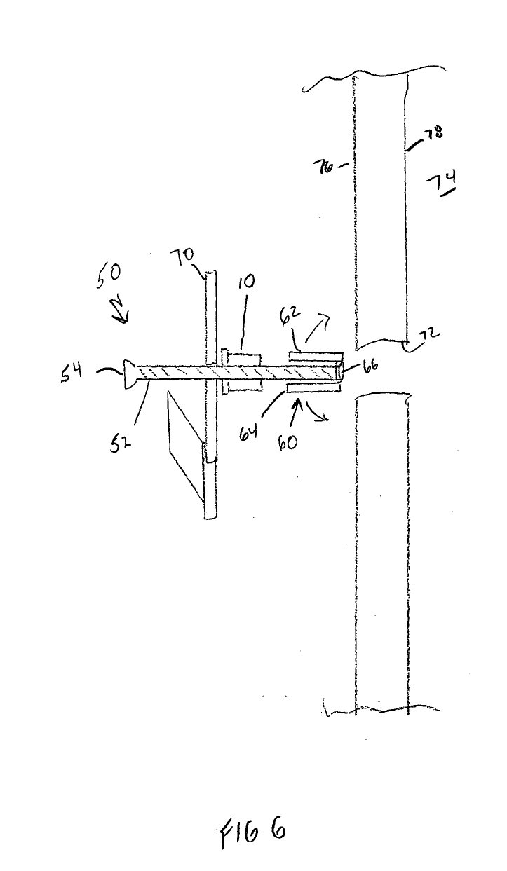

### DETAILED DESCRIPTION OF THE INVENTION

Reinforcing plug insert 10 is generally tubular in nature formed of an outer cylindrical tubular member 12 having a cylindrical outer wall 14 and a cylindrical inner wall 16. A second inner cylindrical tubular member 18 is positioned within first circular tubular member 12 and is concentric therewith having an outer wall 20 and an inner wall 22 thereby defining an annular space 24 between the two concentric tubular members. Inner cylindrical tubular member 18 defines an aperture 26 for receipt of a toggle bolt threaded shank as described hereafter.

Outer cylindrical tubular member 12 and inner cylindrical tubular member 18 emanate from a base member 30 in the form of a washer whose diameter 32 is greater than the diameter of the outer wall 14 of outer cylindrical tubular member 12 thereby forming a flange surface 34 about outer cylindrical tubular member 12. Base member 30 is formed with an aperture coincident with the aperture 26 defined by the inner cylindrical tubular member 18. Reinforcing plug insert 10 is preferably of unitary construction being formed of polymer or the like in a molding process.

In the illustrations, the inner cylindrical tubular member is shown to be of a height less than that of outer cylindrical tubular member 12. This height differentiation is for ease of molding the reinforcing plug insert 10 and it will be recognized by those of ordinary skill in the art that the height of the inner cylindrical tubular member 18 may equal the height of outer cylindrical tubular member 12. The purpose of the inner cylindrical tubular member 18 is to provide support and to centrally orient and position the threaded shank portion of the toggle bolt when installed as described hereafter. Further, the height of the outer cylindrical tubular member 12 may vary but preferably its height is slightly less than the thickness of standard wallboard or plaster board used to frame a hollow wall to allow the toggle to compress against the blind side of the hollow wall when tightened.

It is recognized that the toggle bolt assemblies as illustrated hereafter, come in varying sizes and dimensions. Therefore, the aperture required to be drilled into the hollow wall to accommodate the toggle bolt assembly will vary. Thus the size of the reinforcing plug insert 10 will vary with the size of the aperture. The aperture 26 defined by inner cylindrical tubular member 18 will vary depending upon the diameter of the shank of the toggle bolt. In this regard, the diameter of the base member 30 will also vary depending upon the size of the aperture drilled in the hollow wall, as will the diameter of outer cylindrical tubular member 12. The base member 30 is thin so as to allow the item which is being secured to the hollow wall by the toggle bolt to abut the wall as closely as possible. The base member 30 provides support to the toggle assembly when being tightened and serves to solidify or support that portion of the wall sandwiched between the toggle and the base member. Still further, the base member eliminates the possibility of the reinforcing plug insert 10 from falling into the hollow wall during insertion and assembly.

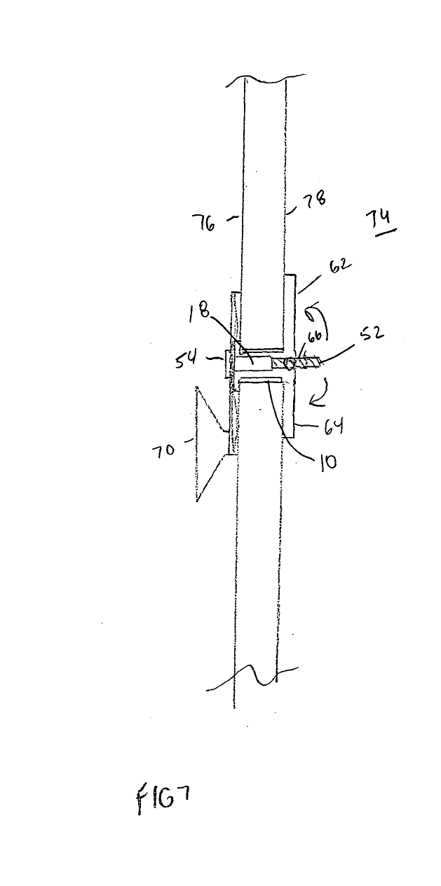

FIG. 6 is a side planar view of an anchor assembly in the form of a toggle bolt utilizing the reinforcing plug insert. FIG. 7 is a side cutaway view illustrating the toggle bolt assembly in a secure attached orientation in a hollow wall. The toggle bolt assembly 50 comprises a threaded metal shank portion 52 having a head end 54, head end 54 having a slot or slots for receipt of a screw driver tip or screw driver bit. The opposing end of threaded shank 52 threadibly receives a toggle 60 comprising two opposing arm members 62 and 64 secured together pivotally by means of a spring biasing means 66.

In a typical installation, the item to be secured to the wall, in this instance, a picture hook 70 as illustrated is slidably received onto the threaded shank 52. The toggle 60 is then threaded received onto the threaded shank 52. An aperture 72 has already been drilled into hollow wall 74. The aperture 72 is of a diameter such that it will allow the threaded shank 52 and toggle 60 to pass through aperture 72 when the arms 62 and 64 of toggle 60 are oriented in substantial alignment with the threaded shank 52. Once the toggle 60 has passed through the aperture 72 and into the hollow of the wall 74, the spring biasing means 66 causes arms 62 and 64 to spring outwardly and orient themselves substantially perpendicular to the threaded shank 52. The application of a screw driver to the head 54 of the toggle bolt assembly rotates the threaded shank 52 passing through the toggle 60 and secures hook 70 in abutting relationship to the exterior surface 76 of hollow wall 74 while the toggle arms 62 and 64 are drawn tightly to the blind surface 78 of hollow wall 74.

In this configuration it can be seen that the threaded shank 52 has substantially less diameter than the aperture 72 allowing for possible movement of the threaded shank 52 and the entire toggle assembly. Exact positioning of any object being used in conjunction with a toggle bolt device is impossible because of the difference between the larger hole being drilled (to allow the toggle to pass through) and the diameter of the bolt. Friction is the only mechanical advantage to offset this problem. Reinforcing plug insert solves this problem with no effort or additional measuring or additional fastening procedures. The insertion of the reinforcing plug insert 10 onto the threaded shank 52 by means of aperture 26, prior to introducing the toggle 60 onto threaded shank 52 allows for reinforcing plug insert 10 to be positioned in aperture 72 while the toggle assembly is tightened. The flange 34 engages the exterior wall surface 76 immediately surrounding aperture 72 and positions itself between the exterior surface and the hook 70. The diameter of cylindrical tubular member 12 is equal to the diameter of the aperture 72 and thus prevents the threaded shank 52 and the entire toggle assembly from movement within aperture 72 when the toggle assembly is fully secured. Reinforcing plug insert solidifies and reinforces the weakened wall once the hole is drilled. Once compromised the composition of the wall material whether sheetrock or plaster can become flake like, brittle, may chip, and/or simply deteriorate which the plug insert prevents.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. An improved anchor assembly for securing a fixture to a hollow wall or ceiling, the anchor assembly comprising a metal toggle assembly including metal toggle bolt with threaded shank, and toggle with spring biased opposing arms for passage through an aperture in said hollow wall or ceiling, the improvement comprising a reinforcing plug insert slidably receivable on said threaded shank of said toggle bolt between said fixture to be secured and said toggle, said reinforcing plug insert having an outer circumference equal to said aperture in said wall, said reinforcing plug insert having a centrally positioned tubular concentric aperture with said outer circumference for support of said threaded shank of said toggle bolt and centrally positioning said threaded shank in said aperture drilled in said hollow wall.

2. An improved anchor assembly for securing a fixture in a hollow wall or ceiling in accordance with claim 1 wherein said reinforcing plug insert is formed with a flange at one end extending outwardly from said outer circumference, said flange in abutting relationship with said hollow wall and said fixture.

3. The improved anchor assembly for securing a fixture to a hollow wall or ceiling in accordance with claim 1 wherein said centrally positioned tubular concentric aperture of said reinforcing plug insert is dimensioned to slidably receive said metal shank portion of said toggle bolt.

4. The improved anchor assembly for securing a fixture to a hollow wall or ceiling in accordance with claim 1 wherein said centrally positioned tubular concentric aperture is equal to or less than the length of said reinforcing plug insert.

5. The improved anchor assembly for securing a fixture to a hollow wall or ceiling in accordance with claim 1 wherein said reinforcing plug insert is of one piece unitary construction.

6. A reinforcing plug insert for use with a wall mounted anchor assembly for securing a fixture to a hollow wall or ceiling, said wall mounted anchor assembly comprising a metal toggle assembly having a metal bolt having a threaded metal shank, a toggle threadedly positioned thereon, said toggle comprising two opposing arms spring biasly mounted and threaded to said metal shank, said reinforcing plug insert being slidably receivable on said metal shank between said fixture to be secured and said toggle, said reinforcing plug insert having an outer circumference equal to the circumference of a hole drilled in said hollow wall, said reinforcing plug insert having an inner tubular concentric aperture dimensioned to the diameter of said metal shank, said reinforcing plug insert securing and positioning said metal shank centrally in said aperture in said wall thereby preventing movement of said shank and said anchor assembly.

7. The reinforcing plug insert in accordance with claim 6 wherein said reinforcing plug insert is formed with a flange at one end extending outwardly from said outer circumference, said flange in abutting relationship with said hollow wall and said fixture.

8. The reinforcing plug insert in accordance with claim 6 wherein said centrally positioned tubular concentric aperture of said reinforcing plug insert is dimensioned to slidably receive said metal shank portion of said toggle bolt.

9. The reinforcing plug insert in accordance with claim 6 wherein said centrally positioned tubular concentric aperture is equal to or less than the length of said reinforcing plug insert.

10. The reinforcing plug insert in accordance with claim 6 wherein said reinforcing plug insert is of one piece unitary construction.
